(19) United States
(12) Patent Application Publication
(10) Pub. No.: US 2004/0064419 A1
(43) Pub. Date: Apr. 1, 2004

(54) Distributed management and administration of licensing of multi-function offering applications

(76) Inventors: David H. J. Glassco, Surrey (CA); Martin M. Lacey, Surrey (CA); Owen D. Walsh, Vancouver (CA); Pavel Vasak, North Vancouver (CA)

Correspondence Address: Aloysius TC AuYeun, Schwabe Williamson & Wyatt, Pacwest Center Suite 1600-1900, 1211 SW Fifth Ave, Portland, OR, 97204-3795, US

(21) Appl. No.: 10/470,067

(22) PCT Filed: Jan. 23, 2002
(86) PCT No.: PCT/IB02/01749

(51) Int. Cl. G06F 17/60

(52) U.S. Cl. 705/59

(57) ABSTRACT

In accordance with a first aspect of the present invention, an account creation/management (ACM) tool is provided to manage and administer administrator and user account creation and management for an application. In one embodiment, the ACM tool is equipped to facilitate administrators of service operators, service providers, and service consumer organizations to jointly administer and manage the creation and empowerment of corresponding service provider and service consumer organization administrator as well as user accounts. In one embodiment, users may have one or more roles, including administrator role(s), and administrator accounts are user accounts of users having such roles. In one embodiment, the ACM tool is also equipped to facilitate the logical creation of the organizations. In accordance with a second aspect of the present invention, a function offering creation/management (FCM) tool is provided to create, manage, and administer access to function offerings and services of the application.

### BACKGROUND OF THE INVENTION

1. Field of the Invention

The present invention relates to the field of electronic data/information processing. More specifically, the present invention relates to methods and apparatuses for managing and administering licensing of multi-function offering applications.

2. Background Information

Historically, software products, whether it is operating systems, system management tools, or applications (hereinafter, simply software), are licensed on a machine by machine basis. In other words, each machine is provided with its own license. Once licensed, any number of users connected to the machine, directly or remotely, may execute one or more copies of the software on the machine. Other software are licensed on a user basis. That is, up a maximum of N users (where N is the number of licensed users) may execute one or more copies of the software on the machine at the same time. Further, for client-server computing, the client and server software may be licensed separately. Numerous ones of such machine as well as user based licensing systems are known in the art.

A common characteristic to many of these prior art software licensing systems is the predetermination of the licensing entity. That is, the functionality that forms the product or package to be distributed/licensed. For example, in the case of Microsoft Office, there is a standard edition and a professional edition, where the constituting applications of the two editions are predetermined and fixed, thereafter distributed and licensed accordingly.

With the advance of telecommunication and networking technology, and the availability of public data networks, such as the Internet, the distribution and licensing software are evolving. It is much easier for a licensee to download the software titles of interest. Moreover, increasingly application software are being offered as hosted application services remotely accessed using special or generic clients. Couple this with the development of increased richness in the functionalities offered by many applications or application services, such as the function rich financial applications or application services available from FinancialCAD of Surrey, Canada, assignee of the present application, a new approach to managing and administering licensing of software is desired.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, in accordance with one embodiment;

FIGS. 2a-2d illustrate the relationships between the various entities of the present invention, including the relationships between the different types of organizations, the account creation and administration method of the present invention, data sharing through publications and subscriptions, and data replication, in accordance with one embodiment;

FIGS. 3a-3b illustrate a data organization of the administrator/user account creation and management tool, in accordance with one embodiment;

FIGS. 3c-3d illustrate properties and methods of a component object under the present invention, in particular, the security attribute, in accordance with one embodiment;

FIGS. 3e-3f illustrate an alternative approach to data organization and security, in accordance with one embodiment;

FIG. 4 illustrates an end user interface of the account creation and management tool, in accordance with one embodiment;

FIG. 5 illustrates the relevant operational flow of the account creation and management tool, in accordance with one embodiment;

FIG. 6 illustrates a function offering/service creation and authorizing method of the present invention, in accordance with one embodiment;

FIGS. 7a-7b illustrate a data organization of the function offering/service creation and management tool, in accordance with one embodiment;

FIGS. 8a-8d illustrate an end user interface of the function offering/service creation and management tool, in accordance with one embodiment;

FIGS. 9a-9d illustrate the relevant operational flows of the function offering/service creation and management tool, in accordance with one embodiment;

FIG. 10 illustrates an overview of the function offering/service execution method of the present invention, in accordance with one embodiment;

FIG. 11 illustrates the relevant operational flow of the runtime controller of FIG. 10, in accordance with one embodiment;

FIG. 12 illustrates a network environment suitable for practicing the present invention, in accordance with one embodiment; and

FIG. 13 illustrates an example computer system suitable for use as one of the administrator/user computer of FIG. 12 to practice the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terms such as accounts, IDs, objects, end-user interfaces, buttons, and so forth, commonly employed by those skilled in the art to convey the substance of their work to others skilled in the art. Parts of the description will be presented in terms of operations performed by a computer system, using terms such as creating, empowering, and so forth. As well understood by those skilled in the art, these quantities and operations take the form of electrical, magnetic, or optical signals capable of being stored, transferred, combined, and otherwise manipulated through mechanical and electrical components of a digital system; and the term digital system include general purpose as well as special purpose data processing machines, systems, and the like, that are standalone, adjunct or embedded.

Various operations will be described as multiple discrete steps performed in turn in a manner that is most helpful in understanding the present invention, however, the order of description should not be construed as to imply that these operations are necessarily order dependent, in particular, the order the steps are presented. Furthermore, the phrase “in one embodiment” will be used repeatedly, however the phrase does not necessarily refer to the same embodiment, although it may. The terms “comprising”, “having”, “including” and the like are synonymous.

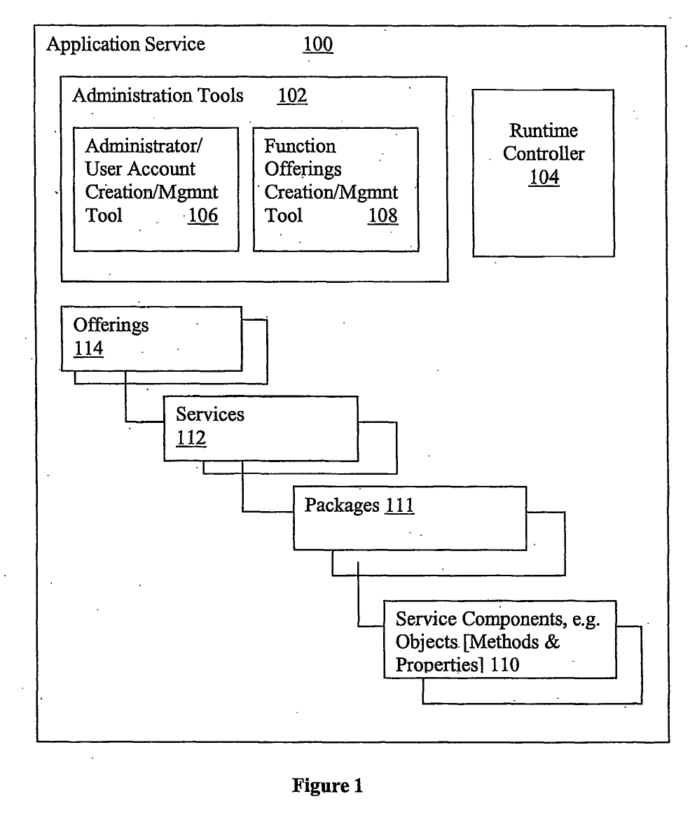

Referring now to FIG. 1, wherein an overview of the present invention in accordance with one embodiment is shown. As illustrated, in accordance with the present invention, Application or application service 100 (hereinafter, including the claims, simply application) having a number of service components 110 (or simply components) is provided with administration tools 102 and runtime controller 104 to facilitate administration and management of user access and usage of components 110. In one embodiment, application 100 is hosted on one or more servers, and the users are remote client users accessing components 110 remotely.

For the illustrated embodiment, as will be described in more details below, components 110 are selectively packaged into packages 111, which in turn are packaged into services 112, and then function offerings 114 for administration and management, i.e. licensing and access/usage control. However, as will be apparent from the description to follow, the present invention may alternatively be practiced with more or less levels of organization/packaging of components 110.

For the purpose of this application, components are programmatic software entities commonly referred to as “objects”, having methods and properties, as these terms are well known in the context of object oriented programming. Packages are groupings of interdependent components similar in functional scope. Services are logical groupings of service functionality that when combined with other services provide broader information processing support. Functional offerings are sets of services offered and licensed to licensees.

Administration tools 104 include in particular account creation/management (ACM) tool 106 and function offering/service creation/management (FCM) tool 108. ACM tool 106 is equipped to facilitate creation of various administrator and end user accounts for various administrators and end users, including facilitation of empowerment of various administrators to administer control on user access to application 100, more specifically, functional offerings 114 and services 112. In one embodiment, the administrator and user accounts are organized by organizations. In one embodiment, at least organizations of three types, service operator, service provider and service consumer, are recognized. In one embodiment, ACM tool 106 is also equipped to facilitate the logical creation of these organizations on the system hosting application 100. FCM tool 108 is equipped to facilitate creation of the various function offerings 114 and services 112, including empowering of the various administrators of the various organizations in administering control on user access to components 110, through invocation of function offerings 114 and/or services 112. In one embodiment, both ACM tool 106 and FCM tool 108 are also equipped to cooperate to facilitate data sharing through publication and subscription, as well as through data replication. These and other aspects of the present invention will be described in turn in the description to follow.

Before proceeding with additional description, it should be noted that application 100 is intended to represent a broad range of application known in the art, including in particular financial applications such as those offered by the assignee of the present invention. Further, while for ease of understanding, the present invention is presented in the context of application 100, from the description to follow, those skilled in the art would appreciate that the present invention may be practiced for other system/subsystem software products or services, as well as other multi-media contents, including but not limited to video, audio and graphics. Accordingly, unless specifically limited, the term “application” as used herein in this patent application, including the specification and the claims, is intended to include system and subsystem software products and services, as well as multi-media contents.

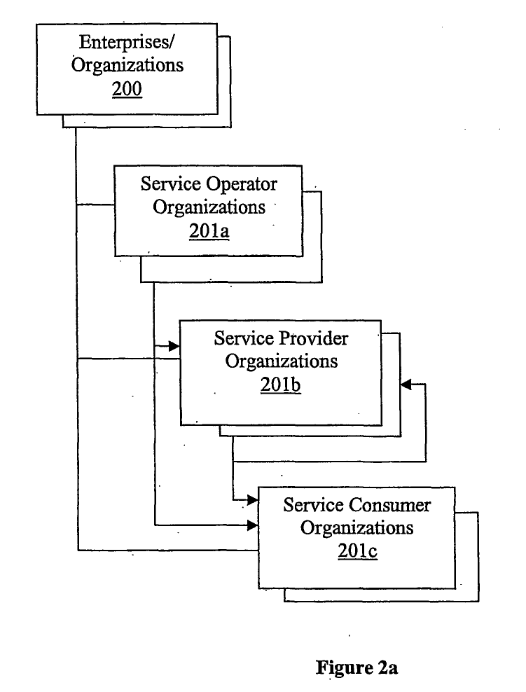

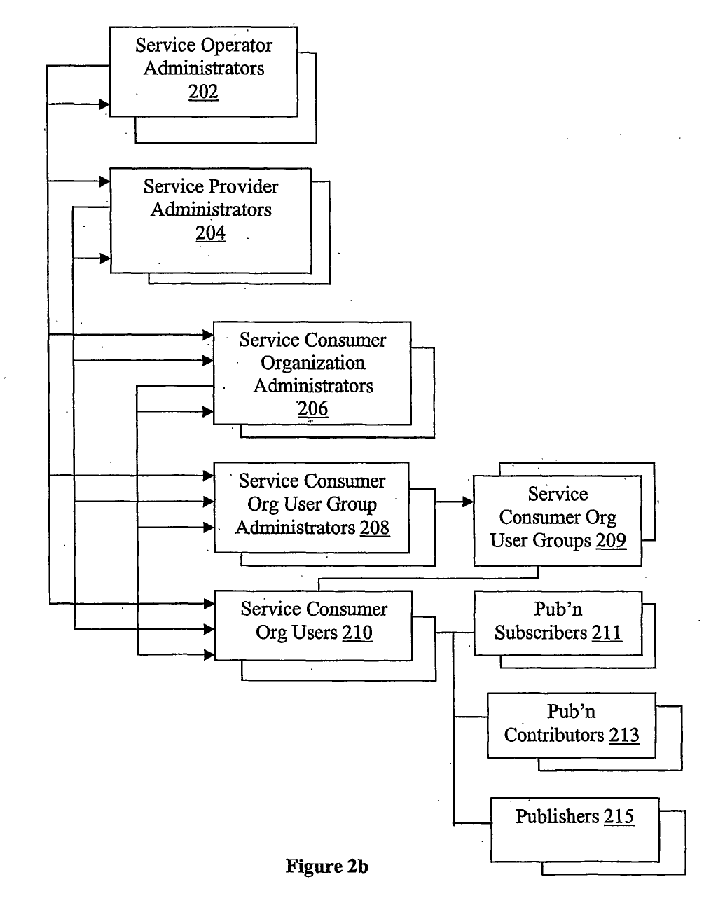

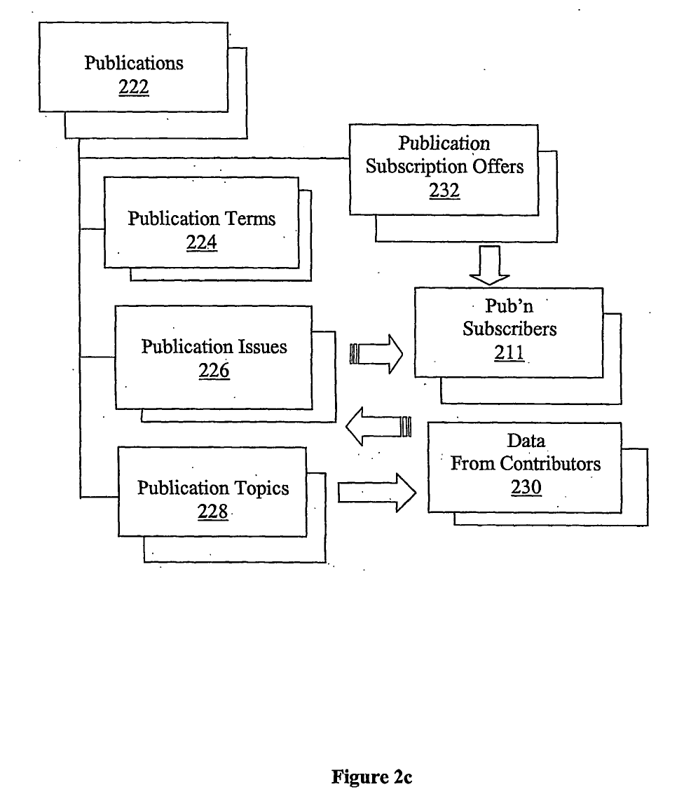

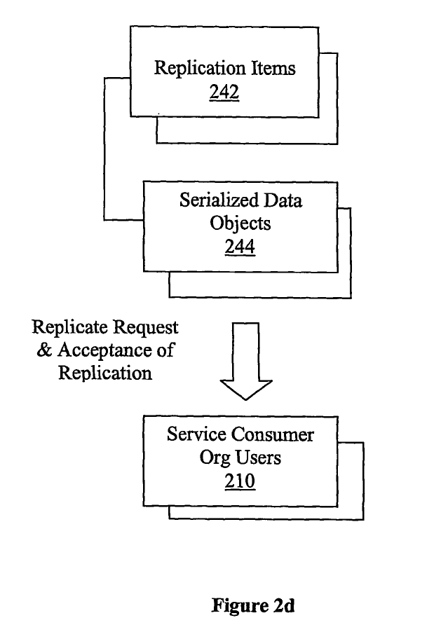

Referring now to FIGS. 2a-2d, wherein an overview of the relationship between the various entities under the present invention, including the relationships between the various organizational types, the administrator and user account creation and management method of the present invention, data sharing through publication and subscription, and data replication, in accordance with one embodiment, is shown. As illustrated in FIG. 2a and alluded to earlier, for the embodiment, organizations 200 may be classified into one of at least three types, service operator, service provider, and service consumer. For the purpose of this application, a service operator organization 201a is an organization that operates the hardware, i.e. one or more servers, hosting application 100, and licenses all or selected combinations of the functions and services of application 100 to service provider organizations 201b, which in turn may license the licensed functions or services, or selected subsets, to one or more other service provider and/or consumer organizations 201b and 201c. A service consumer organization 201c is an organization of users licensed by a service provider organization 201b to use all or a subset of the functions and/or services of application 100 provided by the service provider organization 201b. For the embodiment, a service operator organization 201a may also act in the role of a service provider organization 201b, i.e. licensing all or a subset of the functions/services of application 100 to one or more service consumer organizations 201c directly.

As illustrated in FIG. 2b, for the embodiment, an administrator 202 of a service operator organization creates administrator accounts for administrators of service provider organizations 204. An empowered administrator 202 of a service operator organization may also create administrator accounts for other administrators of the service operator organization. Administrators 202 of the service operator organization also empower administrators 204 of the organization's service provider organizations to further create other administrator and user accounts, and administer control on user access to components 110 of application 100 (through access to functional offerings 114 or services 112).

Continuing to refer to FIG. 2b, an empowered administrator 204 of a service provider organization in turn would create administrator accounts for administrators 206 of service consumer organizations of the service provider organization. Similarly, an empowered administrator 204 of a service provider organization may also create other administrator accounts for other administrators of the service provider organization. An empowered administrator 204 of a service provider organization also empowers administrators 206 of the organization's service consumer organizations to create user accounts for users 210 of the organization's service consumer organizations, and administer control on user access to components 110 of application 100 (through access to functional offerings 114 or services 112) within the respective licensee organizations.

For the illustrated embodiments, service consumer organizations are constituting organization units of licensee enterprises of application 100. Each service consuming licensee enterprise may have one or more physical organization units. Each organization unit may be a wholly owned subsidiary, a division, a group, or a department. In other words, it may be any one of a number of business organizational entities.

Moreover, an empowered administrator 206 of a service consumer organization may also create one or more user groups 209, associates users 210 as members of user groups 209, as well as creating group administrator accounts for user group administrators 208 of the service consumer organization. Similarly, in alternate embodiments, the present invention may also be practiced without the employment of user groups or with more levels of user organizations.

Note that an administrator is also a “user”, only a special “user”, having assumed the role or responsibility of administration. Similarly a service operator or a service provider is also an “enterprise”, only a special “enterprise”, having assumed the role or responsibilities described above for a service operator and a service provider respectively. Moreover, each service operator, as well as each service provider, may have its own “organization” administrators, user groups and users. However, for ease of understanding, the present invention will be described using these terms delineating the roles assumed by the different enterprises/users. Further, the present invention will only be described in terms of a service operator delegating and empowering a service provider, and an empowered service provider in turn delegating and empowering administrators of a service subscribing licensee service consumer organization, and so forth. Those skilled in the art would appreciate that the description applies equally to the service operator/provider's own organization administrator, user groups and end users.

In one embodiment, an empowered administrator 202 of a service operator organization is also able to create the administrator accounts and the end user accounts of a service consumer organization directly, skipping the creation and licensing of a service provider organization, or one or more of the administrators 204 of the organization's licensed service provider organizations, and in the case of user accounts, the administrators 206 of the service consumer organizations. Similarly, an empowered administrator 204 of a service provider organization is also able to create user group administrators 208, user groups 209, and end user accounts for users 210 of a service consumer organization directly, skipping administrators 206 of the organization's service consumer organization. In other words, for the illustrated embodiment, an administrator 202 of a service operator organization may perform all administration and management tasks an administrator 204 of a service provider organization of its creation, as well as an administrator 206 of a service consumer organization of the service provider organization may perform. An administrator 204 of a service provider organization may perform all administration and management tasks an administrator 206 of a of a service consumer organization of its creation may perform.

Thus, it can be seen from the above description, under the present invention, the administration and management of licensing, i.e. logical creation of the organizations, creations of the administrator/user accounts, control of user access to an application, is advantageously hierarchical and decentralized, with the administration responsibilities distributable/delegatable to administrators at various levels of the administration hierarchy. Experience has shown, the hierarchical decentralized or distributed approach is much more flexible, and particular suitable for administering and managing licensing of applications with complex multi-functions, to a large customer base with a large number of end users, across large wide area networks.

Still referring to FIG. 2b, as illustrated, to facilitate data sharing between users of the same and different organizations 210a-210c in a controlled manner, administrators 202-206 of the various organizations 201a-201c may also authorize selected users 210 subject to their administration, to be publishers 215 of data publications 222, data contributors 213 to data publications 222 (if permitted by the owner users 215 of the data publications 222), and/or data subscribers 211 to data publications 222 (also if permitted by the owner users 215 of the data publications 222).

As illustrated in FIG. 2c, a data publisher 215 may create and manage one or more data publications 222, thereby becoming the owner user of the data publications 222. A data publisher user 215 may specify the terms 224 of the data publications 222, such as, the frequency of publication (e.g. weekly, bi-weekly, monthly, and so forth), resulting in the data publications 222 having different publication issue instances 226, and the cost of subscription.

A data publisher user 215 may also specify and authorize one or more other users 210 to contribute their data to selected ones of the data publisher user's data publications 222 (provided the authorized contributor users 213 are also authorized by his/her administrators 202-206 to contribute their data to other users' data publications 222). In other words, under the present invention, a data publication 222 may contain data from the owner publisher user 215 as well as data from non-owner contributor users 213. Moreover, data contribution by non-owner contributor users 213 are subject to the control of the owner of the data publication 222 as well as the administrators 202-206 with administration power over the potential non-owner contributor users 213 authorized by the owner publisher user 215.

A data publisher user 215 may also specify the publication topic 228 of a data publication 222, thereby controlling the nature of the data contributable to the data publication 222.

Further, an administrator of a service consumer organization 210c (or its licensor service operator/provider organization 201a/201b) may also create publication subscription offers 232 to offer data publications 222 for subscription by users of the organization 201c. Authorized users 210 in turn may subscribe to offered publications 232 of interest. That is, under the present invention, data subscriptions are subject to the control of the administrators 202-206, on who may subscribe to data publications 222 as well as what data publications 222 can be subscribed.

Referring now to FIG. 2d, for the embodiment, among the functions and services 112 provided by application 100 is a “data object” replication service (not shown). Accordingly, under the present invention, a user 210 (in particular, users of service operator and provider organizations 201a-201b) may create one or more replication items 242 comprising one or more data objects. Under the present invention, instances of the constituting data objects of each replication item 242 are automatically serialized. More specifically, in one embodiment, instances of the constituting data objects of a replication item 242 are organized as serialized XML (Extended Markup Language) documents. That Is, each replication item 242 may be replicated in accordance with the replication item stood at an instance in time. So, if a replication item 242 has two constituting data objects, a first data object having gone through two updates, and a second data object having gone through one update, which occurred in between the two updates of the first data object, the replication item 242 is organized as serialized XML documents, and may be replicated as it stood originally, after the first update to the first data object, after the first update to the second data object, and after the second update to the second data object.

At a desired point in time, the owner user 210 of a replication item 242 may request a replication service of application 100 to replicate the replication item 242 for one or more intra or cross organization users 210. In response, the replication service of application 100 offers the replication item 242 to each of the specified recipient users 210, to accept ownership for the replication instance of the offered replication item 242. Under the present invention, a specified recipient user 210 may decline and not accept the offer to assume ownership for the replication instance of the replication item 242. If so, the request to replicate for the refused is considered “unsuccessful” or “failed”, and the replication item 242 is not replicated for the refused recipient. For each acceptance (which may occur at some point in time after the offer, in particular, after additional changes had occurred to one or more of the constituting data objects of the offered replication item 242), the replication service of application 100 replicates the replicate item 242 as the replicate item 242 stood at the time the offer was made. That is, the replication item 242 is replicated with prior versions of the data objects that have undergone further changes; more specifically, the replication item 242 is replicated with the versions of these data objects as they stood at the time of the offer.

In one embodiment, a replication item 242 may include a number of operational counters (not shown) to keep track of the number of times offers of the replication item 242 has been requested, the number of times replication instances of the replication item 242 has been accepted, the number of times replication instances of the replication item 242 has been rejected, and the number of times request to replication the replication item 242 has failed.

As will be apparent from the description to follow, data publication and replication architecture of the present invention provides an efficient and flexible, yet controlled, approach to data sharing within and across organizations.

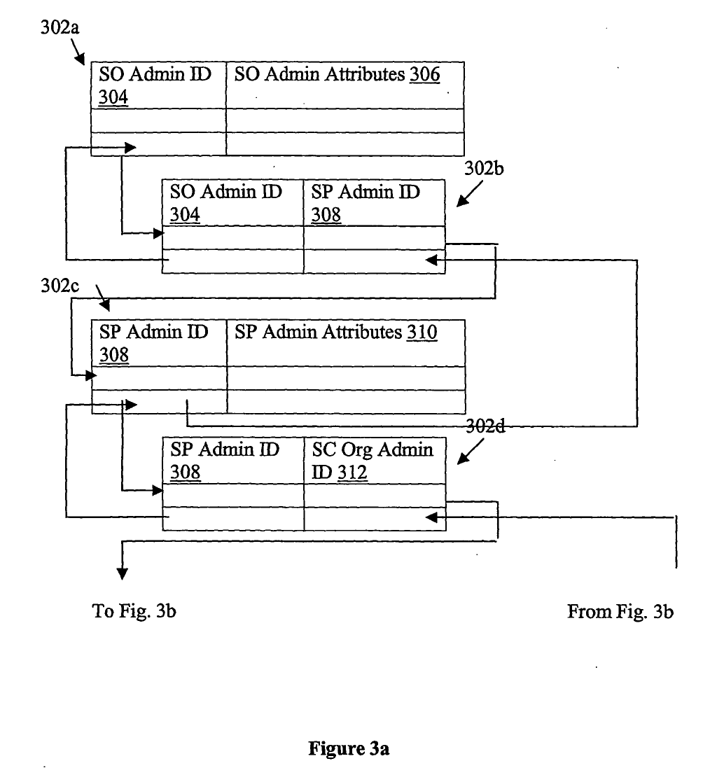

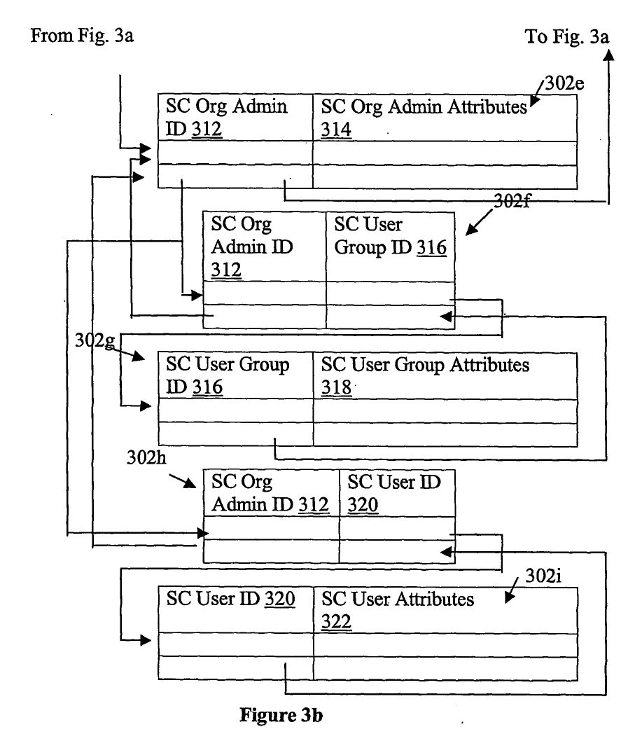

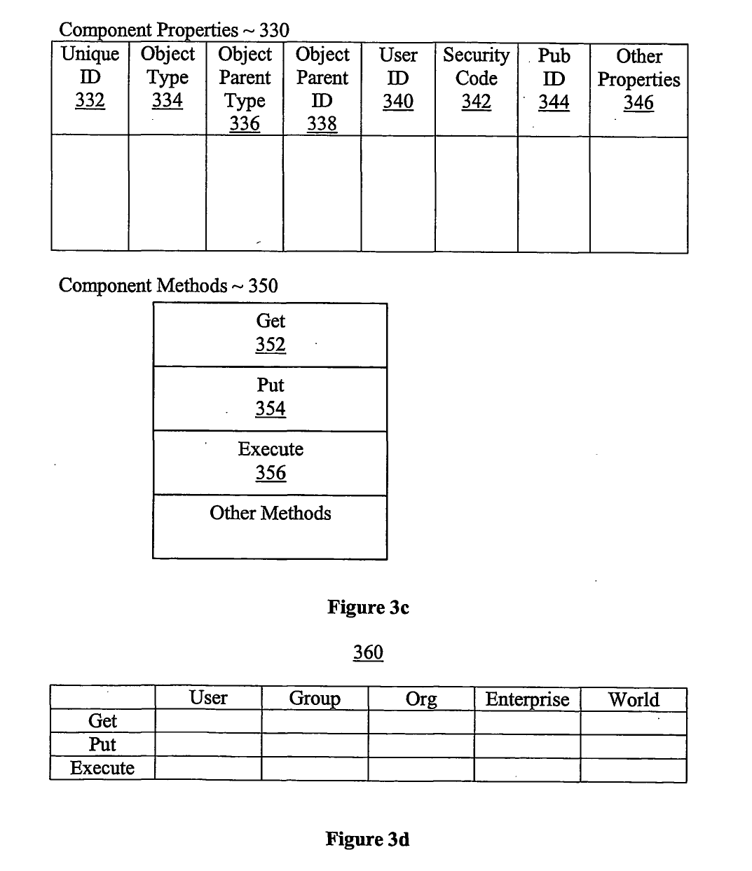

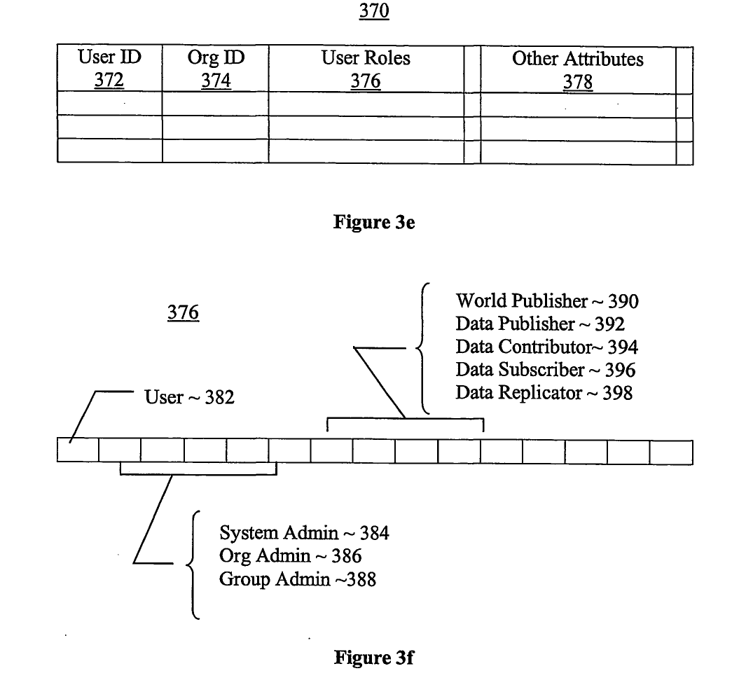

FIGS. 3a-3b illustrate a data organization associated with ACM 106 for the practice of the present invention, in accordance with one embodiment. As illustrated, data organization 300 includes tables or views 302a-302i (hereinafter, simple table or tables). Table 302a is used to store an identifier 304 and basic attribute information 306 for each administrator account of a service operator created. Identifier 304 may be formed in any manner employing any convention. Likewise, attribute information 306 may include any typical account associated information, such as the administrator's name, employee number, department number, phone number and so forth. The exact composition of these attributes is not essential to the present invention, accordingly will not be further described. Table 302b is used to store administrator account identifiers 308 for service provider administrator accounts created by the various service operator administrators denoted by administrator identifiers 304.

Table 302c is used to store an identifier 308 and basic attribute information 310 for each administrator account of a service provider created. Similarly, identifier 308 may be formed in any manner employing any convention, and attribute information 310 may include any typical account associated information. Table 302d is used to store administrator account identifiers 312 for administrator accounts of licensee service consumer organization created by the various service operator administrators denoted by administrator identifiers 308.

Table 302e is used to store an identifier 312 and basic attribute information 314 for each administrator account of a licensee service consumer organization created. Likewise identifier 312 may be formed in any manner employing any convention, and attribute information 314 may also include any typical account associated information, such as the organization administrator's name, customer number, department number, phone number and so forth. The exact composition of these attributes is also not essential to the present invention, accordingly will not be further described either. Tables 302f and 302h are used to store user group identifiers 316 and end user identifiers 320 created by the various administrators of the licensee service consumer organization denoted by organization administrator identifiers 312. Tables 302g and 302i are used to store an identifier 316 and basic attribute information 318 for each user group created, and an identifier 320 and basic attribute information 322 for each end user account created respectively. Likewise identifiers 316 and 320 may be formed in any manner employing any convention, and attribute information 318 and 322 may also include any typical account associated information, such as the user group/end users name, customer number, department number, phone number and so forth. The exact composition of these attributes is also not essential to the present invention, accordingly will not be further described either.

As it can be seen from the description, data organization 300 enables the various types of accounts created, administrator accounts of the service operator and the service providers, administrator accounts of the consumer organizations, user groups, and end user accounts, to be easily ascertained.

In alternate embodiments, other equivalent data organizations include but not limited to flat files, hierarchical databases, linked lists, and so forth, may also be employed instead to practice the present invention.

FIGS. 3c-3d illustrate in further detail the properties of a component 110, its methods, including in particular, the security property associated with each component 110. As illustrated, for the embodiment, each component 110 includes a unique identifier 332 identifying the component, and a type property 334 to identify the object type of the component. Further, each component 110 includes properties 338 and 336 describing the parent object's identifier and the object type of the parent object respectively. Additionally, each component 110 includes property 340 identifying the user owner, property 342 identifying the access rights the user owner has granted to others, and if applicable, property 344 identifying the data publication with which the component is associated with. As illustrated, component 110 may also include other properties 346.

As alluded to earlier, each component 110 has a number of methods. For the illustrated embodiment, the methods 350 include at least a Get method 352 for retrieving data associated with the component and other applicable subscribed publishing components, a Put method 354 to store a copy of data present in the component into memory or mass storage, and an Execute method 356 to perform a pre-determined computation using the data of the component and other applicable subscribed publishing components. Of course, each component 110. may also include other methods.

As illustrated in FIG. 3d, each user owner specifies for himself/herself and other data sharing entities the rights to use these methods, i.e. the Get Method, the Put Method, and the Execute Method. If a data sharing entity is authorized to use the method, all members of the data sharing entity are authorized. In other words, authorization of the members are implicitly given. If authorized, the corresponding “cell” of “table” 360 is set to “true”, otherwise it is set to “false”, denoting the members of the data sharing entity are not authorized to use the method. For example, if a user authorizes himself/herself to use all three methods, then all three “cells” in “column” 1 of “table” 360 are set to “true” or “1”. As a further example, if other members of a group to which the user belongs to is authorized to use the Get method, then the “cell” in “column” 2, “row” 1 of “table” 360 is set to “true” or “1”, and the remaining “cells” in “column” 2, i.e. “rows” 2-3 of “table” 360 are set to “false”. The “cells” of the remaining Org, Enterprise and World columns are set accordingly. [Note that “table” 360 is employed for illustrative purpose only. The authorization data may be stored in any one of a number of known data structures.]

For the illustrated embodiment, for efficiency of storage and efficiency of processing, each digital representation of “1”s and “0”s of a combination of authorized usage of these methods for the various entities is “reduced” to a numeric value and stored in security field 342 for use during operation to control access to the data managed by the components.

In one embodiment, the reduction is performed by a secure runtime service that supports the user owner in making the authorization. Further, the reduction of the digital representation to a numeric value is made in accordance to the following approach:

a) a digital representation is determined for the authorization given to an entity (such as the user, its user group, and so forth), e.g. if the user group is authorized to Get and Execute, but not Put, the digital representation would be “101”;

b) the digital representation would be mapped to a decimal value, e.g. “001” would be 1, and “111” would be 7;

c) the decimal representations are then concatenated together to form the aggregated numeric representation of the authorization granted, and stored as the security property, e.g. if the decimal representations of the authorization granted to user, group, organization, enterprise and world are 7, 5, 3, 2, 0 respectively, the security property is 75320.

FIGS. 3-3f illustrate an alternative security arrangement, in accordance with another embodiment of the present invention. As illustrated in FIG. 3e, the organization identifier 374 of the organization to which a user Is a member is tracked. For the embodiment, each organization is typed, as earlier described. Further, the organization types are tracked (not shown). Accordingly, based on the tracked organization identifier 374 of an organization, the organization type of the organization to which a user is a member may be determined.

Additionally, as illustrated in FIG. 3e, the various user roles 376 a user may operate in, as authorized by the administrators with administrative power over the user, are also tracked. In one implementation, as illustrated in FIG. 3f, all users are authorized to use the functions/services of application 100 authorized for its user group (which may be all or a subset of the functions/service of application 100 licensed to the user's organization) as a user. Additionally, each user may be optionally authorized to operate in a group administrator role 388 for its user group, an organizational administrator role 386 for its organization, and/or a system administrator role 384 (if the user is a member of a service operator or service provider organization). Further, each user may be optionally authorized to operate in a publisher role 392 publishing data publications, a contributor role 394 contributing data to data publications, a subscriber role 396 subscribing to data publications, and/or a replicator role 398 replicating data objects for other users.

In one implementation, for efficiency of administration, a user may also be optionally authorized to operate in a world publisher role 390, whose data publications may be subscribed by any user of any organization.

In one embodiment, the authorized user roles are tracked in a multi-value user role variable.

For the embodiment, in lieu of the earlier described security code 342 and security matrix 360, security is enforced in accordance with these authorized user roles. That is, only users authorized to operate as group administrators may administer the corresponding user groups, only users authorized to operate as organization administrators may administer the corresponding organizations, only users authorized to operate as system administrators may administer the corresponding service operator/provider and their descendant organizations. Further, only users authorized to operate as publishers (or world publisher)) may publish data publications, only users authorized to operate as contributors may tag and contribute their data to data publications (as authorized by the owners of the data publications), and only users authorized to operate as subscribers may subscribe to offered data publications,

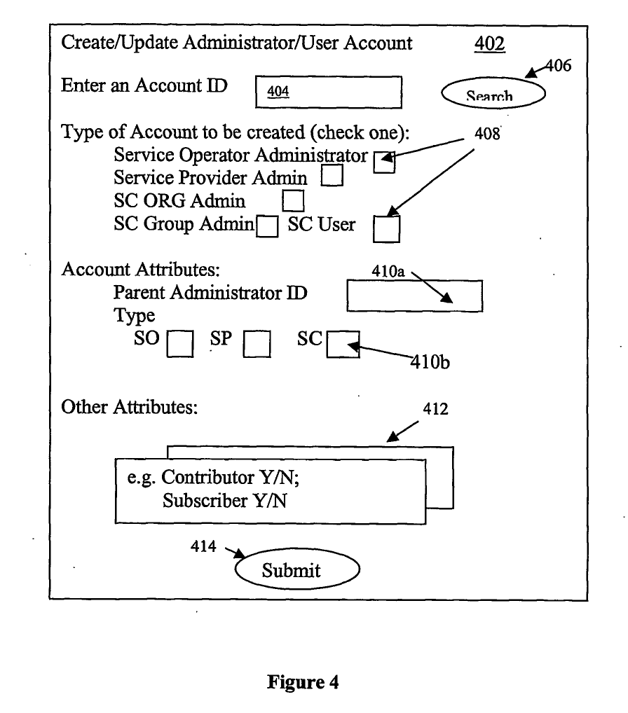

FIG. 4 illustrates an end user interface of ACM 106 suitable for use to practice the present invention, in accordance with one embodiment. For the illustrated embodiment, it is assumed that the account creating/updating administrator has successfully logged into the system (e.g. from a remote administration “console”). That is, the administrator has been properly validated as either the administrator of a service operator, one of the service provider administrators, or one of the organization administrators. Such validation may be made in any one of a number of techniques known in the art. Further, the embodiment allows any of the different accounts to be created/updated. However, as those skilled in the art will appreciate that the present invention may also be practiced with individual end user interfaces, one each of the different account types, or selective combination thereof.

For the embodiment, interface 402 includes field 402 to facilitate entry of an identifier for the account to be created. Further, it includes various check boxes 404 for the administrator to denote the account type of the account to be created. For the illustrated embodiment, selection of the account type of the account to be created also implicitly empowers the account to be created. That is, denoting the account to be created is of the service provider administrator type, implicitly empowers the account holder to be able to create and maintain organization administrator accounts, user groups as well as end user accounts. Likewise, denoting the account to be created is of the organization administrator type, implicitly empowers the account holder to be able to create and maintain user groups as well as end user accounts. For the earlier described embodiment where user roles are tracked in a multi-value user role variable, the selection of the account type results in the appropriate user and/or administrator role values of the multi-value user role variable being set, empowering the user to operate in the corresponding role or roles.

Fields 410 facilitate identification of the parent administrator for the administrator/user account being created. For example, a service provider administrator identifier is to be provided for an organization administrator account to be created, and an organization administrator identifier is to be provided for a user group or an end user account to be created.

Fields 412 facilitate information entry for the various attributes of the administrator/user account to be created/updated. For the illustrated embodiment, fields 412 facilitate in particular the specification of whether the user may be designated as a publisher of data publications, a contributor to contribute data to data publications, whether the user may act in the role of a subscriber, subscribing to offered data publications, and whether the user may create replication items, and request their replications from time to time, as described earlier.

For the embodiment, field 404 may also be used to facilitate entry of an administrator or end user identifier to retrieve the account record of the administrator/end user for update/maintenance. A “search” button 406 is also provided for the logged-in administrator to list and select the various administrator/user account records that are within the administrative scope of the logged-in administrator for update and maintenance. Button 414 submits the administrator/user account for creation or update.

In alternate embodiments, other interface features or interfaces, such as interfaces individualized for the various account types as alluded to earlier, may be used instead to practice the present invention.

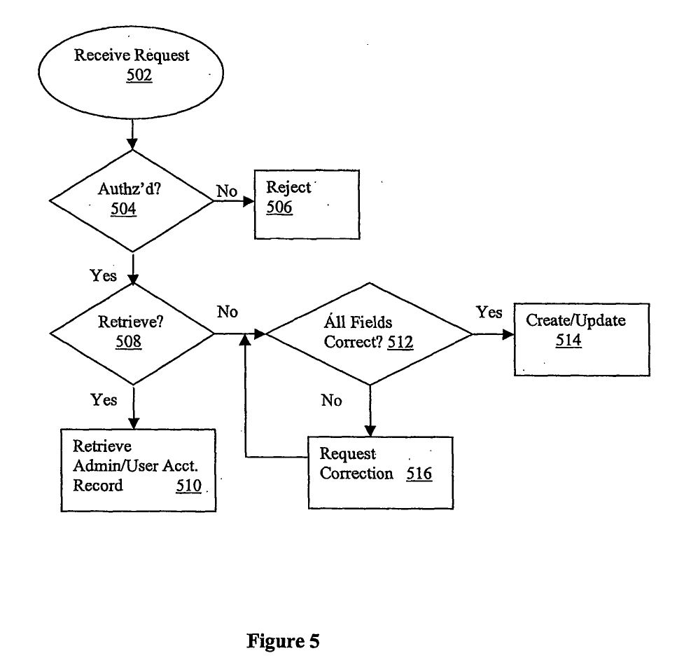

FIG. 5 illustrates the relevant operational flows of ACM 106 for practicing the present invention, in accordance with one embodiment. As illustrated, upon receipt of an event notification associated with the end user interface (hereinafter, simply “request”), ACM 106 determines if the requested operation is authorized or not, block 504, that is whether the logged-in administrator is empowered to perform the requested operation (e.g. in the earlier described embodiment where user roles are tracked in a multi-value user role variable, checking whether the corresponding user role value of the user role variable is set). If not, the requested operation is rejected, block 506, preferably with appropriate rejection notification messages. An example of such unauthorized operation is the request by a logged-in group administrator to create an organization administrator account.

If the requested operation is authorized, ACM 106 determines whether it is an individual record retrieval request or a “list” request, blocks 508-510. ACM 106 then either retrieves the requested individual record (using the administrator/user identifier entered), block 512, or returns a list of administrator/user identifiers that are within the administration scope of the logged-in administrator, block 514. If it is determined at block 508 that the requested operation is not a retrieval request, the requested operation is either an update or create request. ACM 106 proceeds to verify whether all required fields have been properly entered, and whether all entered fields have been entered correctly with the appropriate type of information. The precise nature of error checking is application dependent, and not essential to the practice of the present invention. If one or more errors are detected, correction is requested of the user. Eventually, upon determining that all fields are correct, ACM 106 creates or updates the administrator/user account record as requested, block 520. For the earlier described embodiment where user roles are tracked in a multi-value user role variable, this includes the setting of the appropriate user role values of the user role variable, empowering the users to operate in the corresponding user roles.

Thus, the first aspect of the present invention, i.e. hierarchically and distributively administer and manage the creation of administrator and user accounts, and empowering the administrators to administer control on user access to application 100 has been described.

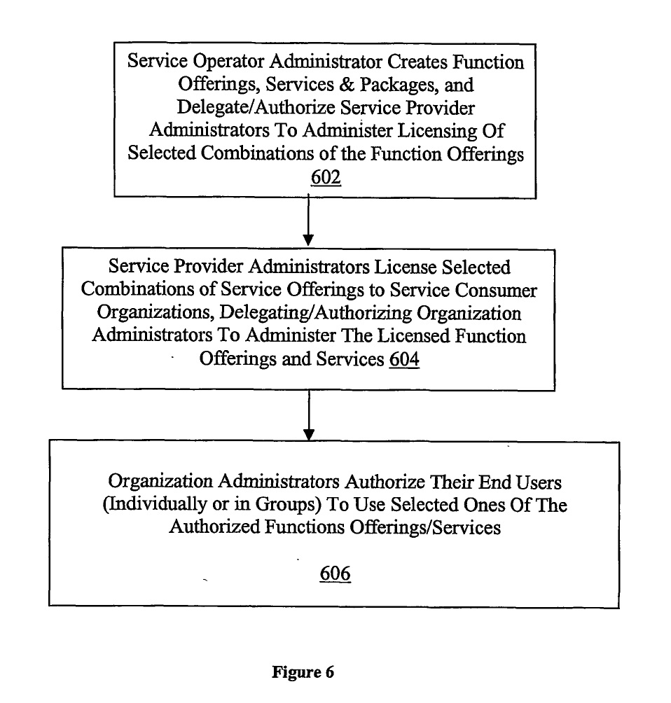

FIG. 6 illustrates the function offering/service creation and access control method of the present invention, in accordance with one embodiment. As illustrated, for the embodiment, a service operator administrator defines and creates various function offerings and services, enumerating their constituting services and service components respectively, and selectively empowers the various service provider administrators to administer control on user access to various ones of the function offerings and/or services, block 602. In turn, for the illustrated embodiment, an empowered service provider administrator selectively empowers other service provider/organization administrators of the service provider/consumer organizations of its creation to administer control on user access to various ones of the function offerings and/or services, block 604. Then, an empowered organization administrator selectively enables members of the user groups and various end users to access various ones of the function offerings and/or services, block 606.

Thus, it can be seen from the above description, functionalities of application 100 may be easily and flexibly defined into different function offerings and/or services for distribution and licensing to different customers, and even different organization units of a customer. Controlling access to these different function offerings and/or services may be readily effectuated through the decentralized administrators.

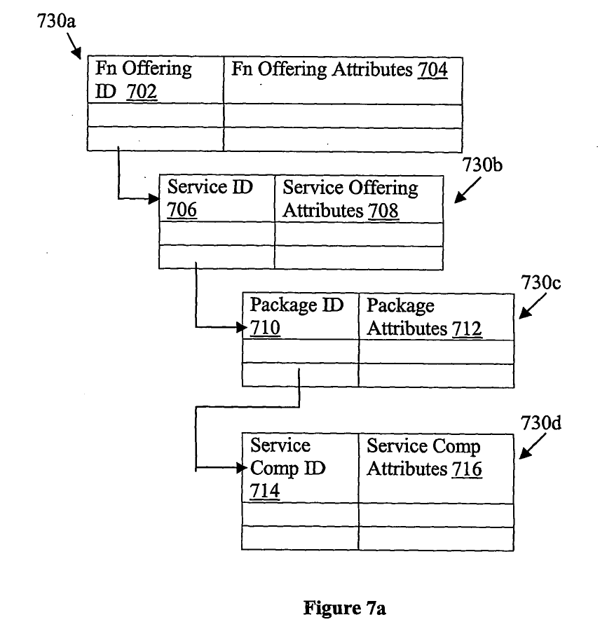

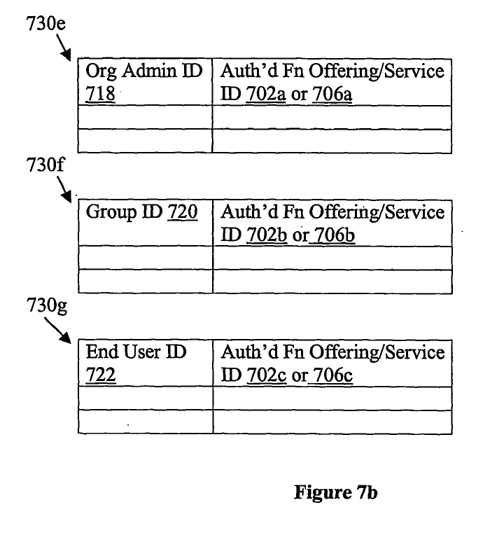

FIGS. 7a-7b illustrate a data organization associated with FCM 108 for practicing the present invention, in accordance with one embodiment. As illustrated, for the embodiment, data organization 700 includes tables/views (hereinafter simply tables) 730a-730g. Table 730a is used to store an identifier 702 and basic attribute information 704 for each function offering created. Identifier 702 may be formed in any manner, employing any convention. Attribute information 704 includes in particular pointers to the constituting services. Beyond that, attribute information 704 may include any typical offering description associated information, such as the offering's name, date of creation, date of last modification, and so forth. The exact composition of these other attributes is not essential to the present invention, accordingly will not be further described. Table 730b is used to store an identifier 706 and basic attribute information 708 for each constituting service created. Similarly, identifier 706 may be formed in any manner, employing any convention. Likewise, attribute information 708 includes in particular pointers to the constituting packages. Beyond that, attribute information 708 may include any typical service description associated information, such as the service's name, date of creation, date of last modification, and so forth. The exact composition of these other attributes is also not essential to the present invention, accordingly will not be further described either.

In like manner, table 730c is used to store an identifier 710 and basic attribute information 712 for each constituting package. Similarly, identifier 710 may be formed in any manner, employing any convention. Attribute information 712 may include any typical package description associated information, such as the package's name, date of creation, date of last modification, and so forth. The exact composition of these other attributes is also not essential to the present invention, accordingly will not be further described either. Table 720d is used to store an identifier 714 and basic attribute information 716 for each constituting service component. Similarly, identifier 714 may be formed in any manner, employing any convention. Attribute information 716 may include any typical service component description associated information, such as the service component' name, date of creation, date of last modification, and so forth, as well as those properties enumerated earlier referencing FIG. 3d. In the present context, the term “attributes” and “properties” may be considered as synonymous. The exact composition of these other attributes/properties, except for the enumerated ones, is also not essential to the present invention, accordingly will not be further described either.

Table 730e is used to store the identifiers 702a and 706a of the various function offerings and services, the various organization administrators (denoted by identifiers 718) are empowered (i.e. authorized) to administer control on their accesses. Tables 730f-730g are used to store the identifiers 702b702c and 706b-706c of the various function offerings and services, the various end users (denoted by identifiers 720-722) are enabled to access.

In alternate embodiments, these data may be organized differently. Further, different data structures may be employed to store the data.

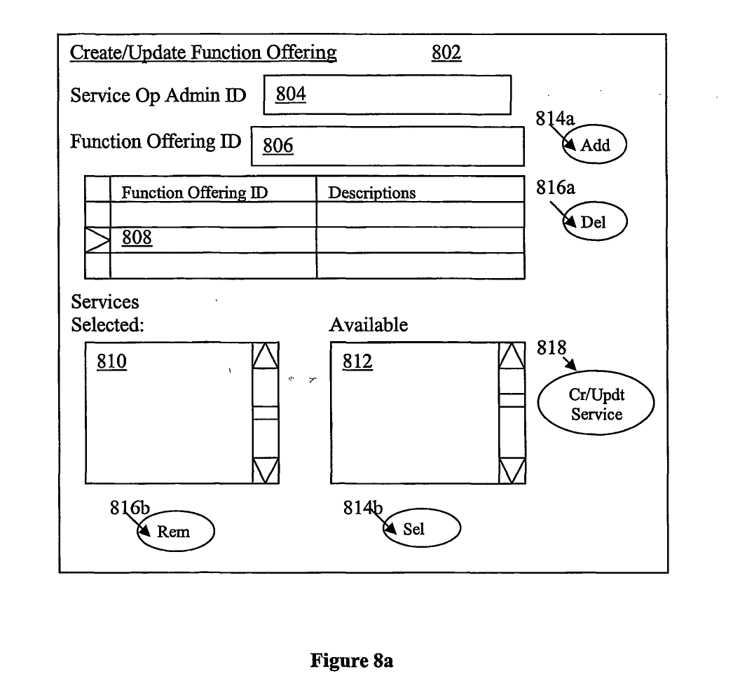

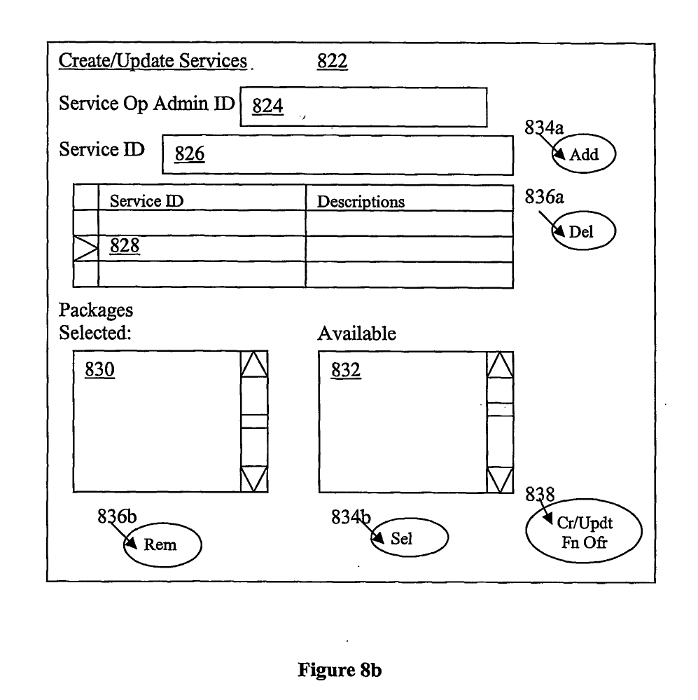

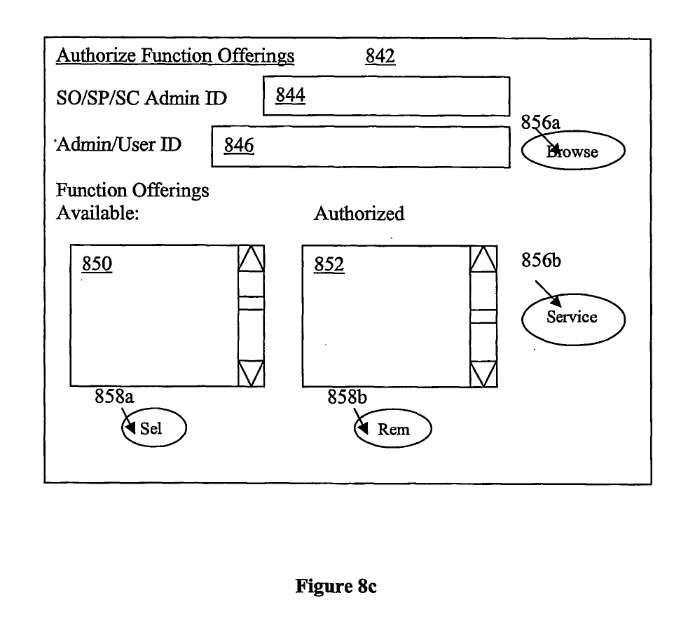

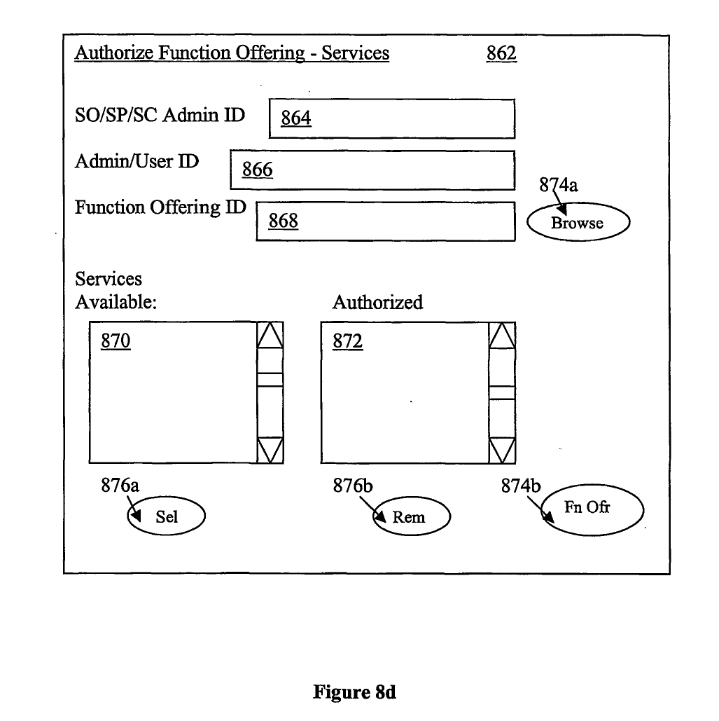

FIGS. 8a-8d illustrate four panes of an end user interface of FOM 108 suitable for use to practice the present invention, in accordance with one embodiment. As illustrated, for the embodiment, pane 802 is used to facilitate creation or update of a function offering (and in some embodiments, to also facilitate in like manner creation or update of a data publication, a data publication offering, and/or a replication item), while pane 822 is used to facilitate creation or update of a service. Pane 842 on the other hand is used to authorize administration or access to function offerings (and in some embodiments, contribution to data publications, and/or offering of data publication offerings to organizations), while pane 862 is used to authorize administration or access to services. For the embodiment, it is assumed that the function offering/service creating administrator (data publication creating data publishers, or data publication offering creating administrators), and the function offering/service administration authorizing (or data publication offering) administrator (or data publishers)have successfully logged into the system (that is having been properly validated as an appropriate administrators, or users authorized to operate in the particular user roles). Of course, in alternate embodiments, all the operations performed via the illustrative end user interface may be accomplished programmatically or via other approaches without the employment of an end user interface.

Pane 802 includes field 804 to reflect the identifier of the logged-in administrator. Pane 802 further includes fields 806 and 808 and “add” and “del” buttons 814a and 816a for facilitating creation of a new function offering or selection of an existing function offering (the logged-in administrator is authorized to manage) for update or delete. As the logged-in administrator enters the name of a function offering in field 806, existing function offerings that match the portion of the name entered thus far are retrieved and displayed in field 808 (which becomes a scrollable list if the number of retrieved function offerings exceeds the amount of space available for display in field 808). If no function offering matches the name entered, field 808 remains empty. The logged-in administrator may “click” on “add” button 814a to have a function offering of the name entered created (its contents remain to be defined). On the other hand, if function offerings matching the name segment entered exist, as alluded to earlier, the names/identifiers of the matching function offerings are displayed in field 808. The logged-in administrator may then select one of the displayed function offering for update or delete. Upon selection, e.g. by “clicking” on a displayed function offering, the name/identifier of the selected function offering is echoed in field 806. The administrator may delete the selected function offering by “clicking” on “del” button 816a.

Pane 802 further includes scrollable fields 810 and 812 and “add” and “del” buttons 814b and 816b for facilitating association or update of services associated with the selected function offering. Scrollable field 812 lists all services available to the administrator to associate with a function offering (i.e. all authorized services with the scope of the administrator’), while scrollable field 810 lists all services associated with the selected function offering. By selecting any of the listed available or associated services, and “clicking” on “sel” (select) and “rem” (remove) buttons 814b and 816b, the administrator may associate an available service with the selected function offering, or remove an associated service from the selected function offering. Lastly, pane 802 includes button 818 for the logged-in administrator to switch to pane 822 to create a new service or update an existing service.

In one embodiment, pane 802 also includes like features (not specifically shown) to facilitate an authorized data publisher in creating or updating data publications in like manner, including specification of the terms of the data publications, and designation of selected users as eligible data contributors for the data publications. Similarly, pane 802 also includes like features (not specifically shown) to facilitate an administrator in creating or updating data publication offerings for selected organizations, and an authorized data replication user in creating or updating data replications items, in like manner.

As illustrated, pane 822 includes field 824 to reflect the identifier of the logged-in administrator. Pane 822 further includes fields 826 and 828 and “add” and “del” buttons 834a and 836a for facilitating creation of a new service or selection of an existing service (the logged-in administrator is authorized to manage) for update or delete. As the logged-in administrator enters the name of a service in field 826, existing services that match the portion of the name entered thus far are retrieved and displayed in field 828 (which becomes a scrollable list if the number of retrieved services exceeds the amount of space available for display in field 828). If no service matches the name entered, field 828 remains empty. The logged-in administrator may “click” on “add” button 834a to have a service of the name entered created (its contents remain to be defined). On the other hand, if services matching the name segment entered exist, as alluded to earlier, the names/identifiers of the matching services are displayed in field 808. The logged-in administrator may then select one of the displayed services for update or delete. Upon selection, e.g. by “clicking” on a displayed service, the name/identifier of the selected service Is echoed in field 826. The administrator may delete the selected service by “clicking” on “del” button 836a.

Pane 822 further includes scrollable fields 830 and 832 and “add” and “del” buttons 834b and 836b for facilitating association or update of service components associated with the selected service. Scrollable field 832 lists all service components available to the administrator to associate with a service (i.e. all authorized service components), while scrollable field 830 lists all service components associated with the selected service. By selecting any of the listed available or associated services, and “clicking” on “sel” (select) and “rem” (remove) buttons 814b and 816b, the administrator may associate an available service component with the selected service, or remove an associated service component from the selected service.

Similar to pane 802, pane 822 also includes button 838 for the logged-in administrator to switch to pane 802 to create a new function offering or update an existing function offering. Accordingly, using buttons 818 and 838, an administrator may switch back and forth between panes 802 and 822, creating and updating function offerings as well as services, in particular, the function offerings' constituting services.

Pane 842 includes field 844 to reflect the identifier of the logged-in administrator. Pane 842 further includes field 846 and “browse” button 826 for facilitating selection of an organization, group or user identifier, within the scope of the logged-in administrator's authority for function offering/service administration. The logged-in administrator may directly enter the organization/group/user identifier to be administered into field 846, or “click” on “browse” button 856a to list organization and group administrators as well as end users within the logged-in administrator's administration scope, and select an administration subject from the list. Pane 842 further includes scrollable fields 850 and 852, as well as “sel” (select) and “del” (delete) buttons 858a and 858b for authorizing function offerings within the administration scope of the logged-in administrator to the administration subject, or removing authorized function offerings of the administration subject. Scrollable field 850 lists all available function offerings, while scrollable field 852 lists all authorized function offerings. Button 858a authorizes a selected available function offering, while button 858a removes a selected authorized function offering. For the illustrated embodiment, authorization of a function offering automatically authorizes all constituting services of the authorized function offering, unless specific actions are taken to revoke the authorization given for some of the constituting services. Lastly, pane 842 includes button 856b for facilitating the logged-in administrator to switch on pane 862 to authorize access at the service level instead (as opposed to the described function offering level).

In one embodiment, pane 842 also includes like features (not specifically shown) to facilitate a data publisher in authorizing data contributors, and an administrator in selecting and authorizing data publications for subscriptions by users of selected organizations in like manner.

Similar to pane 842, pane 862 includes fields 864 and 866 to reflect the identifier of the logged-in administrator and the identifier of the administration subject. Pane 862 further includes field 868 and “browse” button 874a for facilitating selection of a function offering, within the scope of the logged-in administrator's authority for service level administration. The logged-in administrator may directly enter the function offering identifier into field 868, or “click” on “browse” button 874a to list the function offerings within the logged-in administrator's administration scope, and select a function offering from the list. Pane 862 further includes scrollable fields 872 and 870, as well as “del” (delete) and “sel” (select) buttons 876b and 876a for removing authorized services of the selected function offering, and re-authorizing services of the selected function offering. Scrollable field 872 lists all authorized services of the function offering, while scrollable field 870 lists all services of the function offering available for authorization. Button 876b removes a selected authorized service of the function offering, while button 876a reauthorizes a selected available service of the function offering. Lastly, pane 862 includes button 874b for facilitating the logged-in administrator to go to pane 842 to authorize access at the function offering level. Accordingly, using buttons 856b and 874b, an administrator may switch back and forth between panes 842 and 862, authorizing and de-authorizing function offerings as well as services for selected administration subjects.

In alternate embodiments, other interface features as well as interfaces of other designs may be used instead to practice the present invention.

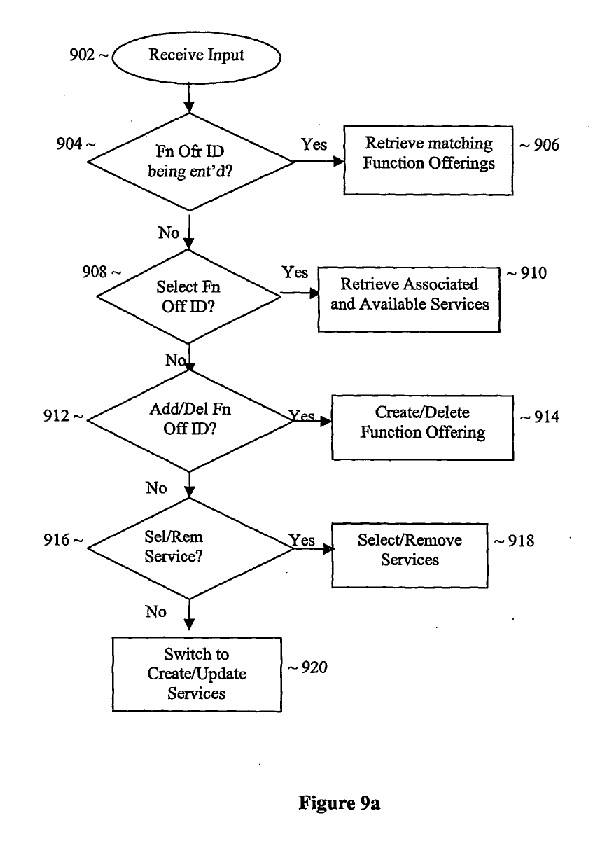

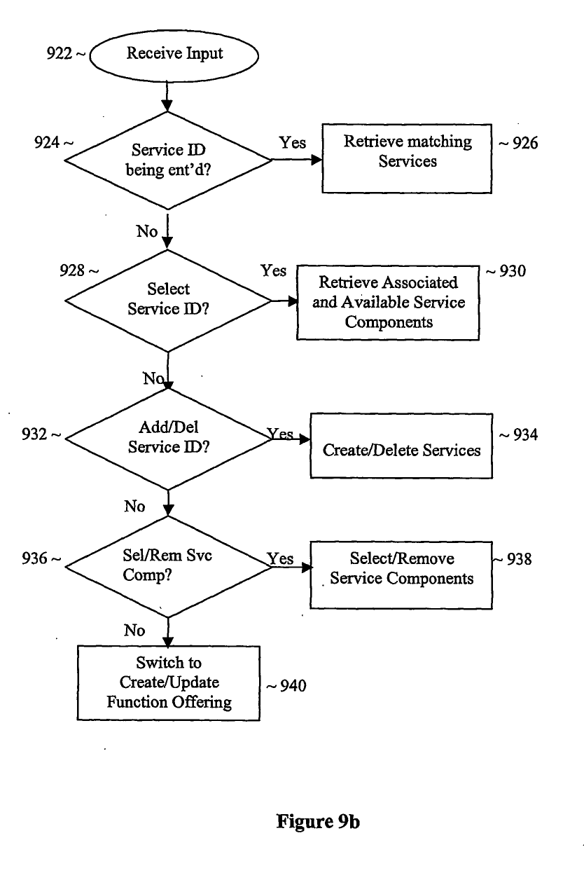

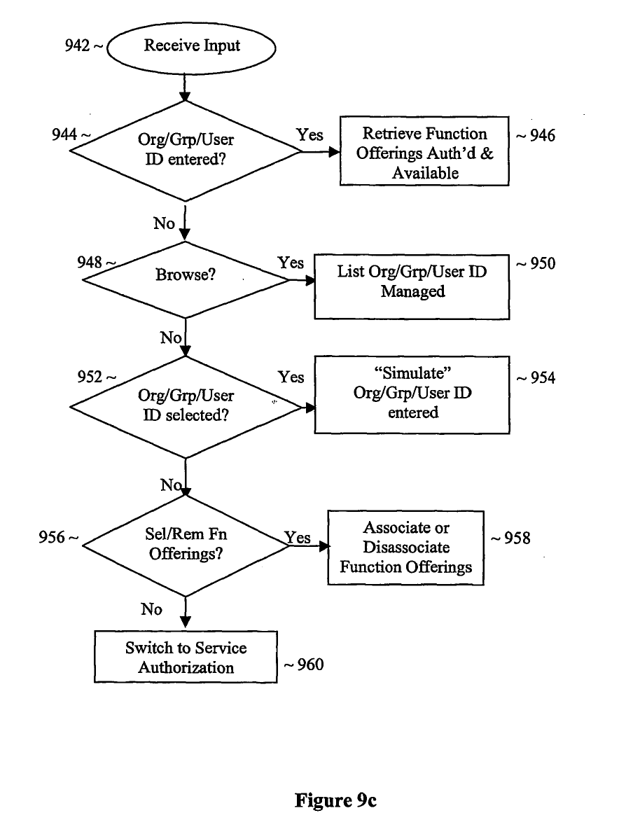

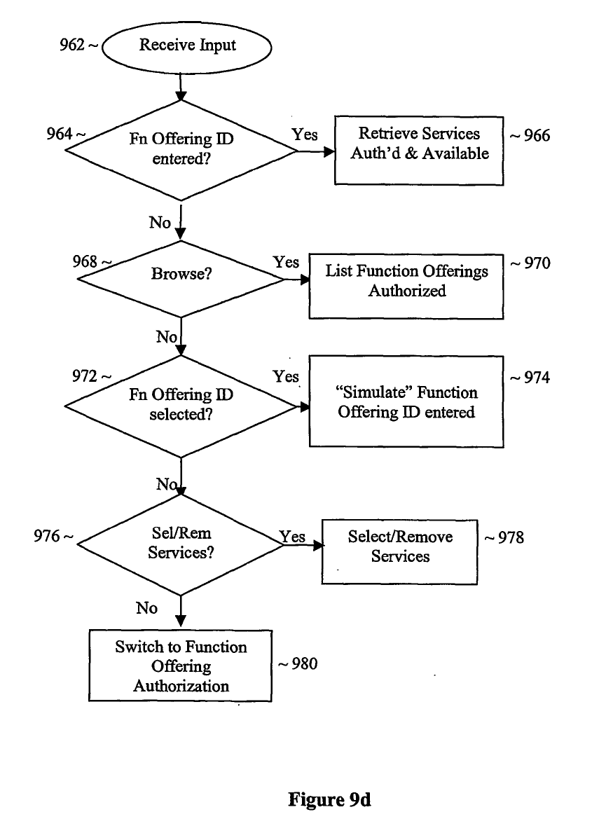

FIGS. 9a-9d illustrate the relevant operational flow of FOM 108 for practicing the present invention, in accordance with one embodiment. More specifically, FIG. 9a illustrates the relevant operational flow for creating/updating a function offering (and in some embodiments, creating/updating of a data publication, a data publication offering, and a data replication item), whereas FIG. 9b illustrates the relevant operational flow for creating/updating a service of a function offering. FIG. 9c illustrates the relevant operational flow for authorizing administration or enabling access to function offerings (and in some embodiments, contributions to data publications, and offering of data publication offerings to organizations), whereas FIG. 9d illustrates the relevant operational flow for authorizing administration or enabling access to services of a function offering.

As illustrated in FIG. 9a, for the embodiment, upon receipt of an event notification associated with the function offering creation/update interface (hereinafter, simply “request”), block 902, FOM 108 determines if the request is associated with a function offering identifier being entered, block 904. If so, FOM 108 retrieves and displays the matching function offerings, block 906. If not, FOM 108 continues at block 908.

At block 908, FOM 108 determines if the request is associated with the selection of a displayed function offering. If so, FOM 108 retrieves the associated services of the selected function offering as well as the services within the scope of the administrator's administration available for association with the selected function offering, block 910. If not, FOM 108 continues at block 912.

At block 912, FOM 108 determines if the request is associated with the addition or deletion of a function offering. If so, FOM 108 creates the newly named function offering or deletes the selected function offering accordingly, block 914. If not, FOM 108 continues at block 916.

At block 916, FOM 108 determines if the request is associated with the selection of a service to be associated with the selected function offering or the removal of an associated service from the selected function offering. If so, FOM 108 associates or disassociates the selected service with the selected function offering accordingly, block 918. If not, for the illustrated embodiment, the request is inferred to be a request to switch to the create/update service pane. Accordingly, FOM 108 switches the create/update service pane and transfers control to its associated logic, block 920.

In embodiments where creation or update of data publications by data publishers, creation and update of data publication offerings by administrators, and creation and update of replication items by authorized users are supported, FOM 108 are equipped to operate in like manner in support of these creations and updates.

Similarly, as illustrated in FIG. 9b, for the embodiment, upon receipt of an event notification associated with the service creation/update interface (hereinafter, simply “request”), block 922, FOM 108 determines if the request is associated with a service identifier being entered, block 924. If so, FOM 108 retrieves and displays the matching services, block 926. If not, FOM 108 continues at block 928.

At block 928, FOM 108 determines if the request is associated with the selection of a displayed service. If so, FOM 108 retrieves the associated service components of the selected service as well as the service components within the scope of the administrator's administration available for association with the selected service, block 930. If not, FOM 108 continues at block 932.

At block 932, FOM 108 determines if the request is associated with the addition of deletion of a service. If so, FOM 108 creates the newly named service or deletes the selected service accordingly, block 934. If not, FOM 108 continues at block 936.

At block 936, FOM 108 determines if the request is associated with the selection of a service component to be associated with the selected service or the removal of an associated service component from the selected service. If so, FOM 108 associates or disassociates the selected service component with the selected service accordingly, block 938. If not, for the illustrated embodiment, the request is inferred to be a request to switch to the create/update function offering pane. Accordingly, FOM 108 switches the create/update function offering pane and transfers control to its associated logic, block 940.

As illustrated in FIG. 9c, for the embodiment, upon receipt of an event notification associated with the function offering authorization/enabling interface (hereinafter, simply “request”), block 942, FOM 108 determines if the request is associated with an organization, group or user identifier being entered, block 944. If so, FOM 108 retrieves function offerings already authorized for the organization/group administrator or user, and function offerings within the scope of the administrator's administration available for authorization, block 946. If not, FOM 108 continues at block 948.

At block 948, FOM 108 determines if the request is associated with listing organization/group administrator and user identifiers within the scope of the administrator's administration. If so, FOM 108 retrieves and displays their identifiers, block 950. If not, FOM 108 continues at block 952.

At block 952, FOM 108 determines if the request is associated with the selection of an organization/group administrator or user identifier. If so, FOM 108 “simulates” entry of the selected identifier, block 954. If not, FOM 108 continues at block 956.

At block 956, FOM 108 determines if the request is associated with the selection of a function offering for authorization or selection of an authorized function offering for de-authorization. If so, FOM 108 authorizes or de-authorizes the selected function offering accordingly, block 958. If not, for the illustrated embodiment, the request is inferred to be a request to switch to service authorization. Accordingly, FOM 108 switches to the service authorization pane, and transfers control to its associated logic accordingly, block 960.

In embodiments where creation or update of data publications by data publishers, and creation and update of data publication offerings by administrators, FOM 108 are equipped to operate in like manner in support of the data publishers in authorizing contribution to data publications, and administrators in offering data publication offerings to users of organizations.

As illustrated in FIG. 9d, for the embodiment, upon receipt of an event notification associated with the service authorization/enabling interface (hereinafter, simply “request”), block 962, FOM 108 determines if the request is associated with a function offering identifier being entered, block 944. If so, FOM 108 retrieves services of the function offering already authorized for the organization/group administrator or user, and other services of the function offering within the scope of the administrator's administration available for authorization, block 966. If not, FOM 108 continues at block 968.

At block 968, FOM 108 determines if the request is associated with listing the function offerings within the scope of the administrators administration. If so, FOM 108 retrieves and displays their identifiers, block 970. If not, FOM 108 continues at block 972.

At block 972, FOM 108 determines if the request is associated with the selection of a function offering. If so, FOM 108 “simulates” entry of the selected function offering's identifier, block 974. If not, FOM 108 continues at block 976.

At block 976, FOM 108 determines if the request is associated with the selection of a service for authorization or selection of an authorized service for de-authorization. If so, FOM 108 authorizes or de-authorizes the selected service of the function offering accordingly, block 958. If not, for the illustrated embodiment, the request is inferred to be a request to switch to function offering authorization. Accordingly, FOM 108 switches to the function offering authorization pane, and transfers control to its associated logic accordingly, block 960.

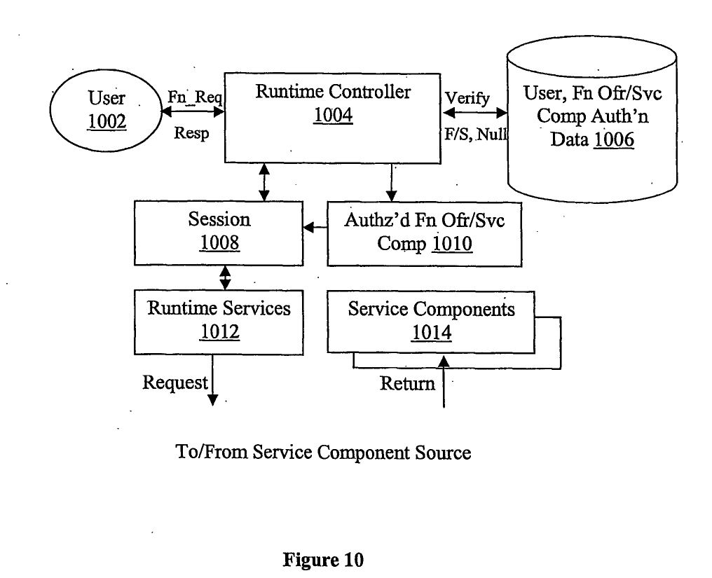

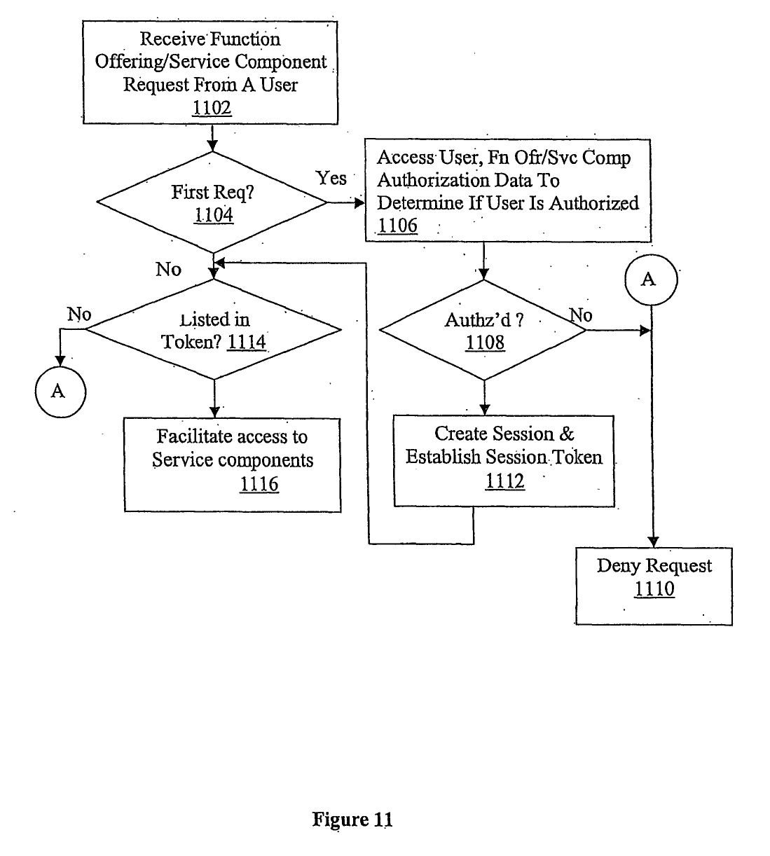

FIGS. 10 and 11 illustrate an overview of a function offering or service launching method of the present invention, in accordance with one embodiment. As illustrated, user 1002 submits a function request (Fn_Req) to runtime controller 1004 (same as runtime controller 104 of FIG. 1) (block 1102). In response, runtime controller 1004 determines if this is the first request from user 1002, i.e. whether a session environment has previously been created for requesting user 1002 (block 1104). If the request is the first request and the session environment is yet to be created, runtime controller 1004 accesses users and function offerings/services authorization database 1008 to verify user 1002 is “enabled”, i.e. authorized to access at least one service or function offering (blocks 1106 and 1108). In one embodiment, if user is “enabled”, runtime controller 1004 also accesses users and function offerings/services authorization data 1008 to determine if the user is an eligible shared data publisher, contributor, subscriber, and/or replicator, and if so, the applicable data publications and/or replication items, if any. Users and function offerings/services authorization data 1008 includes a data organization having user, function offering/service authorization and enabling information similar to the data organization earlier described referencing FIG. 7, and components 110 having security properties 342 as earlier described referencing FIG. 3c (or multi-value user varaible 376 as earlier described referencing FIG. 3f). Further, in an embodiment where data sharing through publication and subscription of data publications, and/or replication itms as earlier described is supported, data 1008 further includes the applicable data publications published, contributed or subscribed by the user, and replication items accessible to the user.

If user 1002 is not “enabled” (authorized) to access at least one service or function offering (nor any shared data), the request is rejected or denied (block 1110). If user 1002 is “enabled” (authorized) to access at least one service or function offering (or at least some shared data), runtime controller 1004 establishes a session environment 1008 for the user, instantiates various runtime services 1012 for the session 1008, retrieves a token 1010 listing all the authorized function offerings and services of the user, and associates token 1010 with session 1008 (block 1112). In an embodiment where data sharing through publication and subscription, and/or replication as earlier described is supported, token 1010 further includes identification of the applicable data publications and/or replication items, if any. For the earlier described publication and subscription approach, applicable ones of the data publications are resolved through the properties of the data publications and related objects. Similarly, accessible data replication items are resolved in like manner.

Upon doing so, or earlier determining that the request is not a first request, and such a session environment had been previously established for the user, runtime controller 1004 transfers the request to an appropriate runtime service to handle (e.g. the earlier described replicate request to a replicate service). Thereafter, runtime services 1012 retrieve and instantiate the appropriate service components or objects associated with the requested service or applicable services associated with the requested function offering 1014 in accordance with whether the requested services/function offerings are among the authorized ones listed in token 1010 created for the session 1008. Further, during execution, the user is conditionally given access to use the earlier described Get, Put, and Execute method associated with the “authorized” service components, depending on whether the user has been given the right to access these methods (blocks 1114-1116). Recall a non-user owner is implicitly given the right to use these methods, for being a member of an authorized user group of the user owner, or a fellow user of the authorized organization/enterprise of the user owner. Altematively, the non-user owner may have been implicitly given the right to use these methods because the user has been authorized to operate in certain user roles.

Moreover, in an embodiment where data sharing through publication and subscription as earlier described is supported, an authorized user is given access to contribute or retrieve data of the applicable data publications. In the presently preferred embodiments, a contributor contributes data to a data publication by tagging the contributing data to the target data publication. Tagging of contributing data to the target data publications result in their association (and not actual copying of the contributing data into the data publication). The data content of a data publication is coalesced together when it is accessed or retrieved by a data subscriber.

Similarly, in an embodiment where data sharing through replication as earlier described is supported, an authorized user is given access to the data objects associated with the applicable replication items. As described earlier, actual replication of an replication item (as it stood at the time of offer) is made only upon acceptance of ownership of the to be replicated item instance by an offeree candidate recipient.

Runtime services 1012 are intended to represent a broad range of runtime services, including but are not limited to memory allocation services, program loading and initialization services, certain database or data structure interfacing functions, and so forth. In alternate embodiments, security token 1010 may be statically pre-generated and/or dynamically updated to reflect dynamic changes in publications and subscriptions.

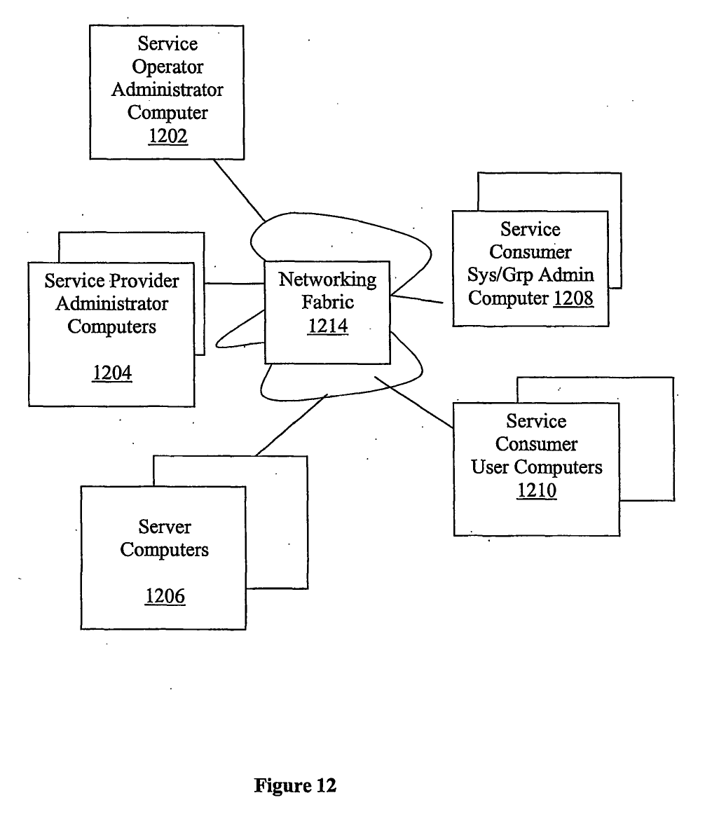

FIG. 12 illustrates a network environment suitable for practicing the present invention. As illustrated, network environment 1200 includes service operator administrator computer 1202, service provider administrator computers 1204, server computers 1206, organization administrator computers 1208, and end user computers 1210. The computers are coupled to each other through networking fabric 1214.

Server computers 1206 are equipped with the earlier described multi-function application 100 including administration tool 102 and runtime controller 104. In selected implementations, all or part of ACM 106 and FOM 108 are instantiated onto the respective computers 1202-1204 and 1208-1210 for execution. Similarly, for selected ones of function offerings 114, services 112, packages 111 or service components 110, all or part of these offerings, services, packages or service components are invoked by end user computers 1212 for execution.

In one embodiment, service operator administrator computer 1202, service provider administrator computers 1204 and server computer 1206 are affiliated with the vendor of application 100, while organization administrator computers 1208, and end user computers 1210 are affiliated with customers or service subscribers of application 100.

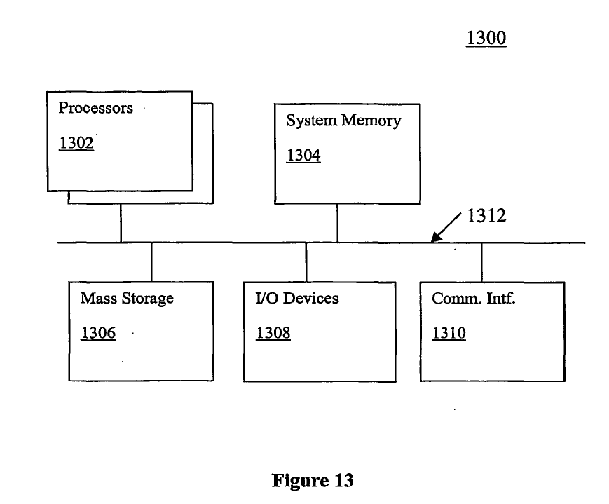

Computers 1202-1210 are intended to represent a broad range of computers known in the art, including general purpose as well as special purpose computers of all form factors, from palm sized, laptop, desk top to rack mounted. An example computer suitable for use is illustrated in FIG. 13. Networking fabric 1214 is intended to represent any combination of local and/or wide area networks, including the Internet, constituted with networking equipment, such as hubs, routers, switches as the like.

As alluded to earlier, FIG. 13 illustrates an example computer system suitable for use to practice the present invention. As illustrated, example computer system 1300 includes one or more processors 1302 (depending on whether computer system 1300 is used as server computer 1206 or other administrator/end user computers 1202-1204 and 1208-1210), and system memory 1304 coupled to each other via “bus” 1312. Coupled also to “bus” 1312 are non-volatile mass storage 1306, input/output (I/O) devices 1308 and communication interface 1314. During operation, memory 1304 includes working copies of programming instructions implementing teachings of the present invention.

Except for the teachings of the present invention incorporated, each of these elements is intended to represent a wide range of these devices known in the art, and perform its conventional functions. For example, processor 1302 may be a processor of the Pentium® family available from Intel Corporation of Santa Clara, Calif., or a processor of the PowerPC® family available from IBM of Armonk, N.Y. Processor 1302 performs its conventional function of executing programming instructions, including those implementing the teachings of the present invention. System memory 1304 may be SDRAM, DRAM and the like, from semiconductor manufacturers such as Micron Technology of Boise, Id. Bus 1312 may be a single bus or a multiple bus implementation. In other words, bus 1312 may include multiple buses of identical or different kinds properly bridged, such as Local Bus, VESA, ISA, EISA, PCI and the like.

Mass storage 1306 may be disk drives or CDROMs from manufacturers such as Seagate Technology of Santa Cruz of Calif., and the like. Typically, mass storage 1306 includes the permanent copy of the applicable portions of the programming instructions implementing the various teachings of the present invention. The permanent copy may be installed in the factory, or in the field, through download or distribution medium. I/O devices 1308 may include monitors of any types from manufacturers such as Viewsonic of City, State, and cursor control devices, such as a mouse, a track ball and the like, from manufacturers such as Logictech of Milpitas, Calif. Communication interface 1310 may be a modem interface, an ISDN adapter, a DSL interface, an Ethernet or Token ring network interface and the like, from manufacturers such as 3COM of San Jose, Calif.

Thus, a method and an apparatus for managing and administering licensing of multi-function offering applications have been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. In an apparatus, a machine implemented method for administering licensing of application services, the method comprising:
facilitating an administrator of a service operator organization in creating one or more administrator accounts for one or more administrators of one or more service provider organizations, and empowering said one or more administrators of said one or more service provider organizations to administer control on user access to function offerings or services of an application by users of licensee service consumer organizations of the service provider organizations;
facilitating an empowered administrator of a service provider organization in creating one or more administrator accounts for one or more administrators of one or more licensee service consumer organizations of the service provider organization, and empowering said one or more administrators of the licensee service consumer organizations of the service provider organization to administer control on user access to function offerings or services of said application by uses of the licensee service consumer organizations of the service provider organization; and
facilitating an empowered administrator of a licensee service consumer organization in creating one or more end user accounts for one or more end users, and enabling said one or more end users to access function offerings or services of said application.

2. The machine implemented method of claim 1, wherein the method further comprises facilitating an administrator of a service operator organization in directly creating one or more administrator accounts for one or more administrators for one or more licensee service consumer organizations of a service provider organization of the service operator organization, and empowering said one or more administrators of said one or more licensee service consumer organizations.

3. The machine implemented method of claim 1, wherein the method further comprises facilitating an administrator of a service operator organization in directly creating one or more end user accounts for one or more end users for one or more licensee service consumer organizations of a service provider organization of the service operator organization, and enabling said one or more end users to access function offerings or services of said application.

4. The machine implemented method of claim 1, wherein the method further comprises facilitating an administrator of a service provider organization in directly creating one or more end user accounts for one or more end users of a licensee service consumer organization, and enabling said one or more end users to access function offerings or services of said application.

5. The machine implemented method of claim 1, wherein the method further comprises facilitating an administrator of a licensee service consumer organization in creating one or more user groups, and enabling members of said user groups to access function offerings or services of said application.

6. The machine implemented method of claim 5, wherein the method further comprises said administrator of the licensee service consumer organization in selectively enrolling end users of the licensee service consumer organization to be members of said user groups of the licensee service consumer organization.

7. The machine implemented method of claim 1, wherein the method further comprises facilitating an empowered administrator of a service operator organization in defining a service constituted with a plurality of service components or a function offering constituted with a plurality of defined services.

8. The machine implemented method of claim 1, wherein the method further comprises facilitating an empowered administrator of a service operator organization in empowering one or more of administrators of one or more service provider organizations to administer authorization of access to function offerings or services of the application by users of licensee service consumer organizations of the service provider organizations.

9. The machine implemented method of claim 1, wherein the method further comprises facilitating an empowered administrator of a service provider organization in empowering one or more administrators of one or more licensee service consumer organizations of the service provider organization to administer authorization of access to function offerings or services of said application by users of the licensee service consumer organizations.

10. The machine implemented method of claim 1, wherein the method further comprises facilitating an empowered administrator of a licensee service consumer organization in authorizing members of one or more user groups of the licensee service consumer organization to access function offerings or services of said application.

11. The machine implemented method of claim 1, wherein the method further comprises facilitating an empowered administrator of a licensee service consumer organization in authorizing end users of the licensee service consumer organization to access function offerings or services of said application.

12. The machine implemented method of claim 1, wherein the method further comprises facilitating an administrator of a service provider organization in authorizing members of one or more user groups of licensee service consumer organizations of the service provider organization to access function offerings or services of said applications.

13. The machine implemented method of claim 1, wherein the method further comprises facilitating an empowered administrator of a service provider organization in authorizing end users of licensee service consumer organizations the service provider organization to access function offerings or services of said application.

14. The machine implemented method of claim 1, wherein
said administrator of the service operator organization is a user of the service operator organization having been authorized to operate in a system administrator role;
said administrator of the service provider organization is a user of the service provider organization having been authorized to operate in a system administrator role; and
said administrator of the service consumer organization is a user of the service consumer organization having been authorized to operate in an organization administrator role.

15. In an apparatus, a machine implemented method of administering licensing of application services, the method comprising:
facilitating an administrator of a service operator organization in creating one or more administrator accounts for one or more administrators of service provider organizations, and empowering said one or more administrators of said service provider organizations to administer control on user access to function offerings or services of said application by end users of licensee service consumer organizations of said service provider organizations; and
facilitating an empowered administrator of a service provider organization in creating one or more administrator accounts for one or more administrators of licensee service consumer organizations of the service provider organization, and empowering said one or more administrators of said licensee service consumer organizations to administer control on user access to function offerings or services of said application by end users of said licensee service consumer organizations.

16. The machine implemented method of claim 15, wherein the method further comprises
facilitating an empowered administrator of a licensee service consumer organization in creating one or more user groups or one or more end user accounts for one or more end users of said the licensee service consumer organization, and enabling members of said user groups or said end users to access to function offerings or services of said application.

17. The machine implemented method of claim 15, wherein
said administrator of the service operator organization is a user of the service operator organization having been authorized to operate in a system administrator role; and
said administrator of the service provider organization is a user of the service provider organization having been authorized to operate in a system administrator role.

18. In an apparatus, a computer implemented method for administering licensing of application services, the method comprising:
facilitating an empowered administrator of a service provider organization of an application in creating one or more administrator accounts for one or more administrators of licensee service consumer organizations of the service provider organization, and empowering said one or more administrators of the licensee service consumer organizations to administer control on user access to function offerings or services of said application by end users of said licensee service consumer organizations; and
facilitating an empowered administrator of a licensee service consumer organization in creating one or more user groups, and empowering members of said one or more user groups to access function offerings or services of said application.

19. The machine implemented method of claim 18, wherein the method further comprises
facilitating an empowered administrator of a licensee service consumer organization in creating one or more end user accounts for one or more end users of said licensee service consumer organization, and enabling said end users to access function offerings or services of said application.

20. The machine implemented method of claim 18, wherein
said administrator of the service operator organization is a user of the service operator organization having been authorized to operate in a system administrator role;and
said administrator of the service consumer organization is a user of the service consumer organization having been authorized to operate in an organization administrator role.

21. In an apparatus, a machine implemented method for administering licensing of application services, the method comprising:
facilitating an empowered administrator of a licensee service consumer organization of an application in creating one or more user groups, and empowering members of said one or more user groups to access function offerings or services of said application; and
facilitating the empowered administrator of the licensee service consumer organization in creating one or more end user accounts for one or more end users of said licensee service consumer organization, and enabling said end users to access said function offerings/services of said application.

22. The machine implemented method of claim 21, wherein said administrator of the service consumer organization is a user of the service consumer organization having been authorized to operate in an organization administrator role.

23. In an apparatus, a machine implemented method for administering licensing of application services, the method comprising:
facilitating an empowered administrator of a service operator organization of an application in creating a first and a second service of said application, constituted with a first and a second plurality of service components of said application respectively, or creating a first and a second function offering of said application, constituted with a first and a second plurality of services of said application respectively, and empowering one or more administrators of a service provider organization of the service operator organization to administer control on user access to said first and second services or the first and second function offerings by end users of licensees of said service provider organization; and
facilitating an empowered administrator of the service provider organization in empowering one or more administrators of licensee service consumer organizations of the service provider organizations to administer control on user access to the first and second function offerings of said application or to said first and second services of said application by end users of said licensee service consumer organizations.

24. The machine implemented method of claim 23, wherein the method further comprises
facilitating a first empowered administrator of a licensee service consumer organization in enabling a first user of the licensee service consumer organization to access said first function offering or said first service; and
a second empowered administrator of a licensee service consumer organization in enabling a second user of the licensee service consumer organization to access said second function offering or said second service.

25. The machine implemented method of claim 23, wherein
said administrator of the service operator organization is a user of the service operator organization having been authorized to operate in a system administrator role; and
said administrator of the service provider organization is a user of the service provider organization having been authorized to operate in a system administrator role.

26. In an apparatus, a machine implemented method for administering licensing of application services, the method comprising:
facilitating an empowered administrator of a licensee service consumer organization of an application in empowering members of one or more user groups of the licensee service consumer organization to access a first and a second function offering of said application, constituted with a first and a second plurality of services of said application respectively, or a first and second service of said application, constituted with first and second plurality of service components of said application respectively; and
facilitating the empowered administrator of the licensee service consumer organization in enabling a first user of the licensee service consumer organization to access said first function offering or said first service; and
facilitating the empowered administrator of the licensee service consumer organization in enabling a second user of the licensee service consumer organization to access said second function offering or said second service.

27. The machine implemented method of claim 26, wherein said administrator of the service consumer organization is a user of the service consumer organization having been authorized to operate in an organization administrator role;

28. An apparatus comprising:
a storage medium having stored therein a plurality of programming instructions implementing an account creation/management tool that, when executed, facilitates creation by an administrator of a service operator organization of an application, one or more administrator accounts for one or more administrators of one or more service provider organizations, and empowerment of said one or more administrators of said one or more service provider organizations to administer control on user access of function offerings or services of said application by end users of licensee service consumer organizations of said service provider organizations; the programming instructions, when executed, further facilitate creation by an empowered administrator of the service operator organization, one or more administrator accounts for one or more administrators of said licensee service consumer organizations of said service provider organizations, and empowerment of said one or more administrators of said licensee service consumer organizations of said service provider organizations to administer control on user access to function offerings or services of said application by end users of said licensee service consumer organizations of said service provider organizations; and
at least one processor coupled to the storage medium to execute said programming instructions.

29. The apparatus of claim 28, wherein the storage medium further having stored therein a second plurality of programming instructions implementing an application offering creation/management tool, when executed, facilitates definition by said administrator of said service operator organization, a plurality of services of said application, constituted with service components of said application, or a plurality of function offerings of said application, constituted with services of said application, and empowerment of said administrators of said service provider organizations to administer control on user access to said function offerings or said services of said application.

30. The apparatus of claim 28, wherein
said administrator of the service operator organization is a user of the service operator organization having been authorized to operate in a system administrator role;
said administrator of the service provider organization is a user of the service provider organization having been authorized to operate in a system administrator role; and
said administrator of the service consumer organization is a user of the service consumer organization having been authorized to operate in an organization administrator role.

31. An apparatus comprising:
a storage medium having stored therein a plurality of programming instructions implementing an application offering creation/management tool that, when executed, facilitates creation by an administrator of a service operator of an application, one or more services of said application, constituted with service components of said application, or one or more function offerings of said application, constituted with services of said application; the programming instructions, when executed, further at least assists in authorization by an empowered administrator of a licensee consumer organization of a licensee service provider organization of the service operator organization, of members of one or more user groups administrators of said licensee consumer organization to function offerings or services of said application by end users of said licensee service consumer organization; and
at least one processor coupled to the storage medium to execute said programming instructions.

32. The apparatus of claim 31, wherein
said administrator of the service operator organization is a user of the service operator organization having been authorized to operate in a system administrator role; and
said administrator of the service consumer organization is a user of the service consumer organization having been authorized to operate in an organization administrator role.

33. An apparatus comprising:
a storage medium having stored therein a plurality of programming instructions implementing an account creation/management tool that, when executed, facilitates creation by an empowered administrator of a licensee service consumer organization of an application, one or more user groups, and empowering members of said one or more user groups to access function offerings or services of said application by end users of said licensee service consumer organization; and facilitates creation by an empowered administrator of said licensee service consumer organization, one or more end user accounts for one or more end users of said licensee service consumer organization, and enabling said end users to access function offerings or services of-said application; and
at least one processor coupled to the storage medium to execute said programming instructions.

34. The apparatus of claim 33, wherein the storage medium further having stored therein second plurality of programming instructions implementing an application offering creation/management tool, when executed, facilitates authorization by an empowered administrator of a licensee service consumer organization members of one or more user groups of the licensee service consumer organization to access function offerings or services of said application by end users of said licensee organization.

35. The apparatus of claim 33, wherein the second programming instructions, when executed, further facilitates enabling by said administrator of said licensee service consumer organization, a first and a second end user of said licensee service consumer organization to access function offerings or services of said application.

36. The apparatus of claim 33, wherein said administrator of the service consumer organization is a user of the service consumer organization having been authorized to operate in an organization administrator role.
